(19) United States
(12) Patent Application Publication
(10) Pub. No.: US 2023/0284817 A1
(43) Pub. Date: Sep. 14, 2023

(54) MODULAR RECONFIGURABLE MANUALLY ACTUATED ESPRESSO MACHINE

(71) Applicant: Odyssey Espresso LLC, Denver, CO (US)

(72) Inventor: Ross Ainsworth, Denver, CO (US)

(73) Assignee: Odyssey Espresso LLC, Denver, CO (US)

(21) Appl. No.: 18/181,968

(22) Filed: Mar. 10, 2023

Related U.S. Application Data
(60) Provisional application No. 63/318,974, filed on Mar. 11, 2022.

(51) Int. Cl. A47J 31/38; A47J 31/06

(52) U.S. Cl. CPC A47J 31/38; A47J 31/0657

(57) ABSTRACT

The present invention is directed to an apparatus for producing coffee, espresso for instance, with the capability to be modularly reconfigured for operation as a manual lever operated espresso machine, or alternatively configured as a spring lever operated espresso machine, preferably without the use of specialized tools or the removal or replacement of major components from operational use.

### CROSS REFERENCE TO RELATED APPLICATIONS

This application claims the benefit of U.S. Provisional Patent Application 63/318,974 entitled “MODULAR RECONFIGURABLE MANUALLY ACTUATED ESPRESSO MACHINE” filed on Mar. 11, 2022, the entire contents of which are incorporated herein by reference in its entirety for all purposes.

### FIELD OF THE INVENTION

The present invention is directed to a device for producing coffee, espresso for instance, with the capability to be modularly reconfigured for operation as a manual lever operated espresso machine, or alternatively configured as a spring lever operated espresso machine.

### BACKGROUND OF THE INVENTION

Coffee, a caffeine containing beverage, is generally consumed for the purposes of taste, benefits of caffeine, and leisure. Many forms of coffee beverages are known as far as the forms in which it is consumed.

In particular, the brewing of espresso is considered by many as the purist distillation of the coffee bean, and amongst the most recognizable form of coffee which serves as the basis of countless drinks around the world. Many apparatus and methods have been dedicated to the production and pursuit of perfection when producing espresso.

Although there are notable differences in the production of espresso pertaining to variables such as: the amount of coffee, the ground particulate size of the coffee, the temperature of the water, and the time of extraction—the fundamental intended end-product is the same.

Over centuries the development of apparatus and processes for the production of espresso has fueled entire industries in the pursuit of the best espresso. Espresso making apparatus range from the fully manual to the fully automated, with processes which range from requiring user input at all times to fully automated apparatus which only require the push of a button. Further still, some espresso making apparatus rely on pre-manufactured espresso placed within single-use container for the final processing.

Recent movements toward full control over all variables of the process resulted in the desire for less automation and more user control over the espresso brewing process. Manually actuated machines such as the direct lever or spring lever machine, which each require the actuation of a lever by a user, provide maximum user control over the brewing process.

A direct lever apparatus relies upon the direct input of a user to apply force to a lever which applies pressure within the brewing chamber within which the ground coffee is placed. Within the brewing chamber, the pressure forces hot water through the ground coffee resulting in the production of the espresso. Such configurations provide maximum user control. However, manual lever machines rely solely upon a user to apply force to a lever which directly translates into the production of the espresso. Every variation in force applied by the user results in a variation in pressure applied within the brewing chamber. Thus, although manual lever machines are viewed as the pinnacle of bespoke espresso production by some, their use is accompanied by a steep learning curve in the use thereof.

Alternatively, a spring lever apparatus—another manually actuated espresso apparatus—relies upon a user to actuate a lever which compresses a spring. The spring in turn applies force within the brewing chamber to force water through the ground coffee. The differentiating aspect of the spring lever configuration versus the direct lever configuration lies in the use of the compression spring. The use of the compression spring results in a repeatable pressure profile within the brewing chamber. Spring lever apparatus are commonly seen as preferred for certain scenarios, as they require less attention and eliminate some variability in the production of espresso. However, some users prefer the use of a direct lever at times as the nature of a compression spring, as dictated by Hooke's law, results in a non-linear application of force. Further, it may be desired to apply less pressure at the beginning of the brewing of espresso and increase pressure toward the end of the process. However, Hooke's law demonstrates that the initial application of pressure from the compression spring would be at a maximum at the beginning of the espresso production process and taper to a minimum at the end of the espresso production process.

In view of the uses, benefits, differences, and potential drawbacks associated with a direct lever espresso making apparatus and a spring lever espresso making apparatus—users are currently required to choose one type of apparatus or the other. Some users may go so far as to purchase one of each type of apparatus. However, the countertop surface available, and budget required for owning two separate manually actuated espresso machines is prohibitive.

Therefore, there is an identified need for a manually actuated espresso making apparatus which allows the user to reconfigure the apparatus to operate as a manual lever espresso machine or a spring lever espresso machine as desired.

### SUMMARY OF THE INVENTION

It is an aspect of the present invention to provide a manually actuated espresso making apparatus wherein a user is able to selectively configure the apparatus between a direct lever configuration and a spring lever configuration.

It is an aspect of the present invention to provide the selective configurability of the apparatus between a direct lever and a spring lever configuration to require identical components, but for the absence of a compression spring in the direct lever configuration.

Certain embodiments of the present invention comprise a boiler configured to have fluid communication with a brewing chamber, commonly referred to as a “group head” in the coffee industry. The brewing chamber, or group head, is configured to receive hot water from the boiler, and ground coffee, wherein the brewing chamber is configured to force the hot water through the ground coffee with a piston which travels through the bore of the brewing chamber. The water travels through the ground coffee, and through a filter, prior to being dispensed into a vessel desired by the user. The filter prevents the ground coffee from being dispensed into the resulting beverage. In certain embodiments the brewing chamber is configured to receive ground coffee through the use of a specialized filtered cup commonly referred to as a “portafilter”. A portafilter is typically interconnected to a bottom aspect of the group head through the use of a quarter turn locking system.

In a direct lever configuration, a first end of a lever is pivotally interconnected to the apparatus. The lever is also pivotally interconnected with a piston, wherein the lever's interconnection to the piston is offset proximally from the first end of the lever. Thus, in order to brew coffee in the direct lever configuration, the user first lifts the second end of the lever which raises the piston and draws water into the brewing chamber from the boiler. The user then presses the second end of the lever downward, thereby driving the piston downward through the bore of the brewing chamber and forcing the water through ground coffee placed between a filter and the piston.

In a spring lever configuration, a compression spring is disposed between a top of the piston and a mechanical stop, such as a flange. When the piston is raised, the compression spring is compressed and thus the compression spring applies pressure to drive the piston downward through the bore of the brewing chamber. In the spring lever configuration, the first end of the lever is pivotally interconnected with the piston. The lever is also pivotally interconnected with the apparatus, wherein the lever's interconnection to the apparatus is offset proximally from the first end of the lever. Thus, in order to brew coffee in the spring lever configuration, the user first presses the second end of the lever downward, which raises the piston and compresses the compression spring. The user then releases the second end of the lever, the compression spring thereby drives the piston downward through the bore of the brewing chamber and forcing water though the ground coffee placed between a filter and the piston.

It is an aspect of certain embodiments of the present invention to provide data feedback surrounding the brewing process, wherein the apparatus for brewing coffee comprises data gathering components such as thermocouples, pressure sensors, and flow sensors.

It is an aspect of the present invention to communicate coffee brewing data feedback to a user wirelessly to a user through a user's computing device such as a computer, laptop, smart phone, smart watch, or other wirelessly enabled device. In certain embodiments of the present invention, the apparatus senses, stores, records, and communicates information such as pressure profile in relation to time during the brewing process.

Certain existing espresso making machines such as disclosed in U.S. Patent Publication No. 2007/0277676 to Crivellin (“Crivellin”), incorporated herein by reference in its entirety for all purposes, surround a manually actuated coffee making machine comprises a group head having a tube interconnecting the boiler with the group head in a manner to minimize the length of the tube. The minimized length of tube minimizes the thermal loss as the water is communicated from the boiler to the group head. For example, the tube of Crivellin exits the top of the boiler to limit thermal loss. Furthermore, in such prior art examples, the thermal control is limited to the sensing of the temperature of the water within the boiler. When using such machines, due to the thermal mass of the group head, a user is typically required to cycle the machine initially to heat up the group head. This practice is sometimes referred to as “pulling a blank shot” in coffee producing parlance. The practice of pulling a blank shot is required to ensure that the temperature of coffee brewed thereafter is at a suitable temperature. Each serving of espresso that is served thereafter approaches the temperature of water within the boiler. Thus, the temperature of the boiler must be maintained near the optimal operating temperature of the group head and suitable temperature for a serving of coffee.

In prior art examples such as Crivellin, the head-space above the water level of the boiler is used to produce steam for the steaming of milk and other liquids for addition to the coffee, such as is common practice for producing café au lait, or cappuccino coffee drinks. As the temperature of the boiler must be maintained near the suitable temperature of the coffee, the steam pressure and temperature available for steaming milk is limited and often insufficient for multiple cycles.

It is an aspect of certain embodiments of the present invention to reduce the thermal heat loss from the brewing chamber. Thus, in certain embodiments, the piston comprises a recess through a top aspect of the piston, wherein the recess is configured to receive a spring therein for the spring lever configuration. The nesting of the spring within the recess allows for a shorter height of the brewing chamber, thus decreasing effective external surface area of the brewing chamber, thus decreasing thermal loss from the brewing chamber to the environment.

It is an aspect of certain embodiments of the present invention to allow a user to operate an apparatus for the brewing of coffee wherein the resulting produced coffee is at a desired temperature on the first cycle, and eliminating the need to pull a blank shot. Certain embodiments of the present invention comprise a first thermocouple configured to measure the temperature of the water within the boiler, and a second thermocouple configured to measure the temperature of the group head. A processor, interconnected with the thermocouples also controls the power input to the boiler and thus controls the temperature within the boiler. With a predetermined algorithm wherein the temperature of the water within the boiler is prepared to a temperature which results in the dispensing of the first cycle, and each subsequent cycle of coffee, at a desired temperature.

Certain embodiments of the present invention comprise a tube interconnecting the boiler with the group head wherein the tube follows extended or tortuous path from the boiler to the group head. For example, in certain embodiments, the tube exits the bottom aspect of the boiler, extends upward on an external aspect of the boiler, and into the bore of the brewing chamber. The extended or tortuous path of the tube between the boiler and the brewing chamber results in heat loss to the environment, and requiring a higher boiler setpoint to result in the desired temperature of the beverage when dispensed. The higher boiler setpoint results in increased steam and pressure capacity which results in increased steam available for steaming milk and other liquids for use in a coffee drink.

It is a known problem in existing lever actuated expresso making machines wherein a pocket of air is trapped between the ground coffee and the bottom surface of the piston. Resultantly, effort provided by a user in a manual lever machine or effort provided by a spring in a spring lever machine is partially expended in compressing the entrapped air rather than the incompressible water. Often a solution is not provided and thus the user must either provide increased effort to overcome the compressibility of the air, or a spring with higher stiffness is required which in turn requires more effort from the user to overcome the inefficiency associated with compressing the entrapped air. It is an aspect of the present invention to purge air entrapped between the ground coffee and the bottom aspect of the piston to mitigate the inefficiencies associated with compressing the entrapped air. In certain embodiments a one-way valve or purge valve for eliminating the entrapped air between the ground coffee and the piston.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### BRIEF DESCRIPTION OF THE DRAWINGS

FIG. 1—A perspective view of certain embodiments of a coffee making apparatus of the present invention

FIG. 2—A perspective view of certain embodiments of a coffee making apparatus of the present invention

FIG. 3—A side view of certain embodiments of a coffee making apparatus of the present invention

FIG. 4A—A side transparent view of certain embodiments of a coffee making apparatus of the present invention

FIG. 4B—A cross sectional view of a tube of certain embodiments configured to communicate water from a boiler to a brewing chamber

FIG. 5A—A perspective exploded view of a brewing chamber assembly of certain embodiments

FIG. 5B—A side exploded view of a brewing chamber assembly of certain embodiments

FIG. 6A—A front view of a coffee brewing apparatus of certain embodiments in a direct lever configuration

FIG. 6B—A side cross sectional view of the coffee brewing apparatus of FIG. 6A in a direct lever configuration

FIG. 6C—A detail view of the coffee brewing apparatus of FIG. 6B in a direct lever configuration

FIG. 6D—A detail view of the coffee brewing apparatus of FIG. 6B in a direct lever configuration

FIG. 7A—A front view of a coffee making apparatus in a spring lever configuration

FIG. 7B—A side cross sectional view of the coffee making apparatus of FIG. 7A in a spring lever configuration

FIG. 8—A system view of certain embodiments of the present invention

FIG. 9—A process for brewing coffee as applied to certain embodiments of the present invention

FIG. 10A—A perspective view of a piston of certain embodiments of a coffee making apparatus

FIG. 10B—A top view of a piston of certain embodiments of a coffee making apparatus

FIG. 10C—A section view of the piston shown in FIG. 10B

FIG. 10D—A detail view of the piston shown in FIG. 10C

FIG. 11A—A side view of a piston of certain embodiments of a coffee making apparatus

FIG. 11B—A section view of the piston shown in FIG. 11A

FIG. 11C—A top view of a piston of certain embodiments of a coffee making apparatus

FIG. 12A—A perspective exploded view of a top-plate of a boiler with a boiler cap of certain embodiments

FIG. 12B—An assembled perspective view of the embodiment shown in FIG. 12A

FIG. 13A—A side view of a top-plate of a boiler of certain embodiments with a boiler-cap in an unlocked configuration

FIG. 13B—A section view of the embodiment shown in FIG. 13A

FIG. 14A—A front view of a top-plate of a boiler of certain embodiments with a boiler-cap in a locked configuration

FIG. 14B—A section view of the embodiment shown in FIG. 14A

FIG. 15A—A bottom view of a top-plate of a boiler of certain embodiments with a boiler-cap in a locked configuration

FIG. 15B—A bottom view of a top-plate of a boiler of certain embodiments with a boiler-cap in a vented configuration

### DETAILED DESCRIPTION OF VARIOUS EMBODIMENTS

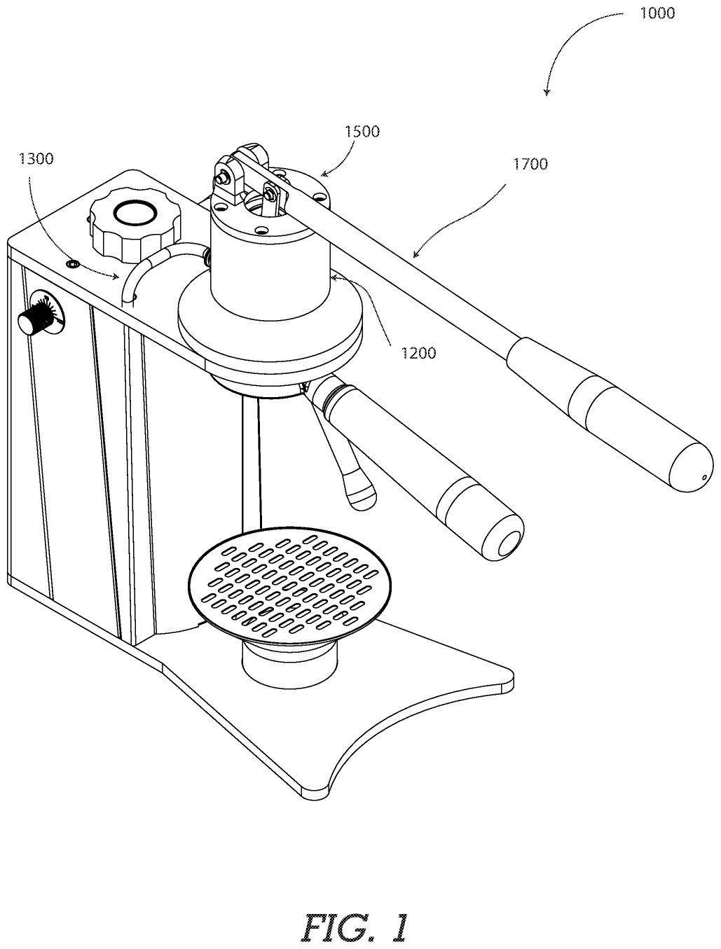

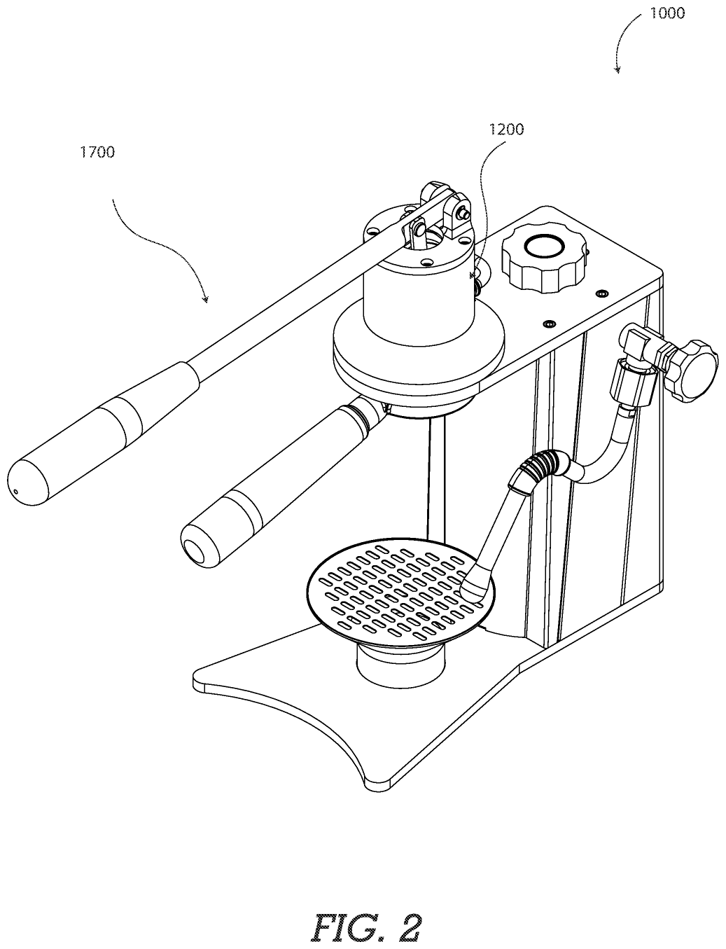

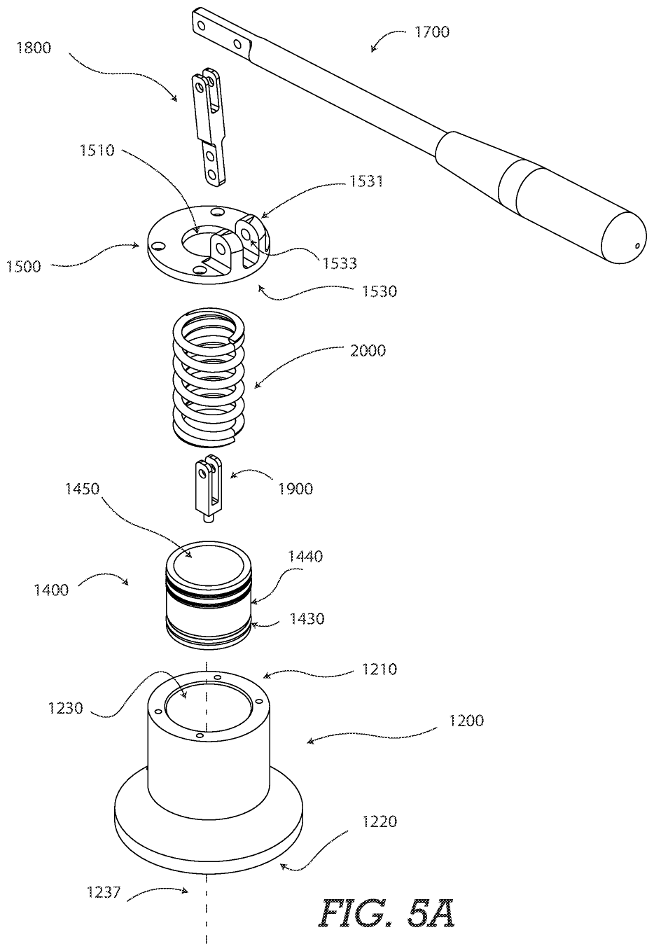

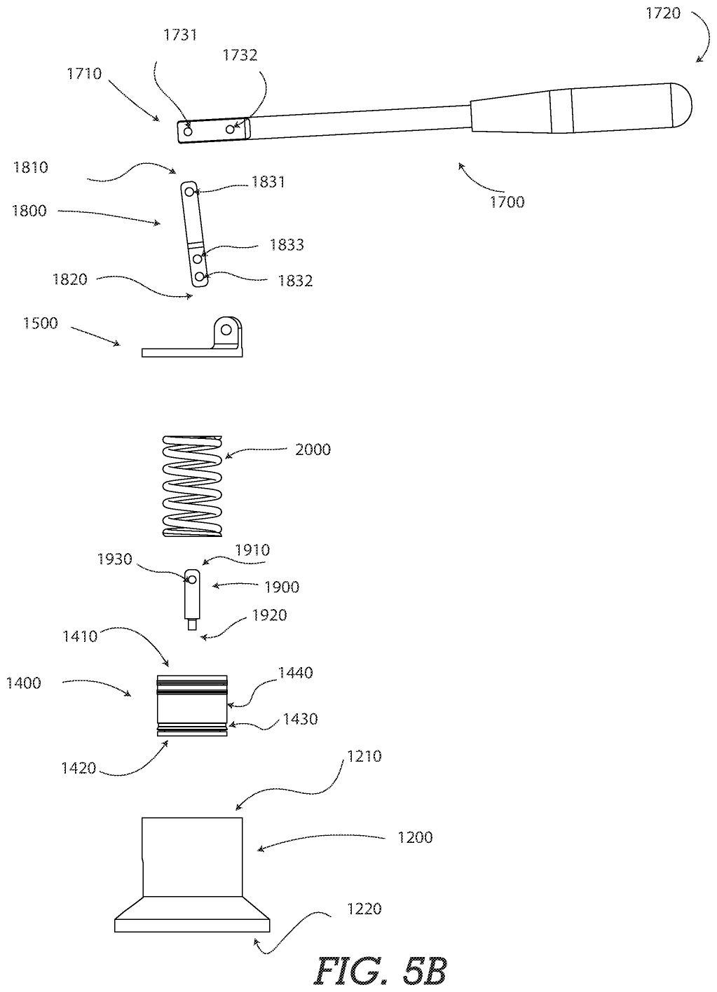

Certain embodiments of the present invention, for example as shown in FIG. 1—FIG. 5B, comprise a manually actuated coffee brewing apparatus 1000 intended for the brewing of espresso and the like. The apparatus comprises a boiler 1100 configured to heat a volume of water to a desired temperature for the brewing of coffee. Water is poured into the boiler 1100 though the top of the boiler when a boiler cap 1150 is removed. The boiler 1100 is fluidly interconnected with a brewing chamber 1200 via a tube 1300. The brewing chamber 1200 comprises a bore 1230 configured to receive a piston 1400 therein. A flange 1500 is configured to interconnect to a top aspect 1210 of the brewing chamber, wherein the flange 1500 comprises an aperture 1510 therethrough wherein the aperture 1510 is collinear with the bore 1230 of the brewing chamber. The bottom 1220 of the brewing chamber is configured to receive ground coffee between a filter 1600 and the bottom aspect of the piston 1420. In certain embodiments a premeasured amount of ground coffee is deposited within a portafilter 1610 which is then interconnected to the bottom aspect 1220 of the brewing chamber.

In certain embodiments, the bore 1230 of the brewing chamber is configured to receive hot water from the boiler through the tube 1300 in an upstroke, wherein the piston 1400 travels upward within the bore 1230 of the brewing chamber. The piston 1400 comprises sealing engagement through the use of sealing elements 1430, such as O-rings placed circumferentially around the piston. In certain embodiments, the piston 1400 comprises a plurality of sealing rings for maintain a seal between sidewalls 1440 of the piston and the bore 1230 of the brewing chamber, thus preventing hot water from traversing from a bottom aspect 1420 of the piston, past the sidewalls 1440 of the piston, and out the top 1210 of the brewing chamber.

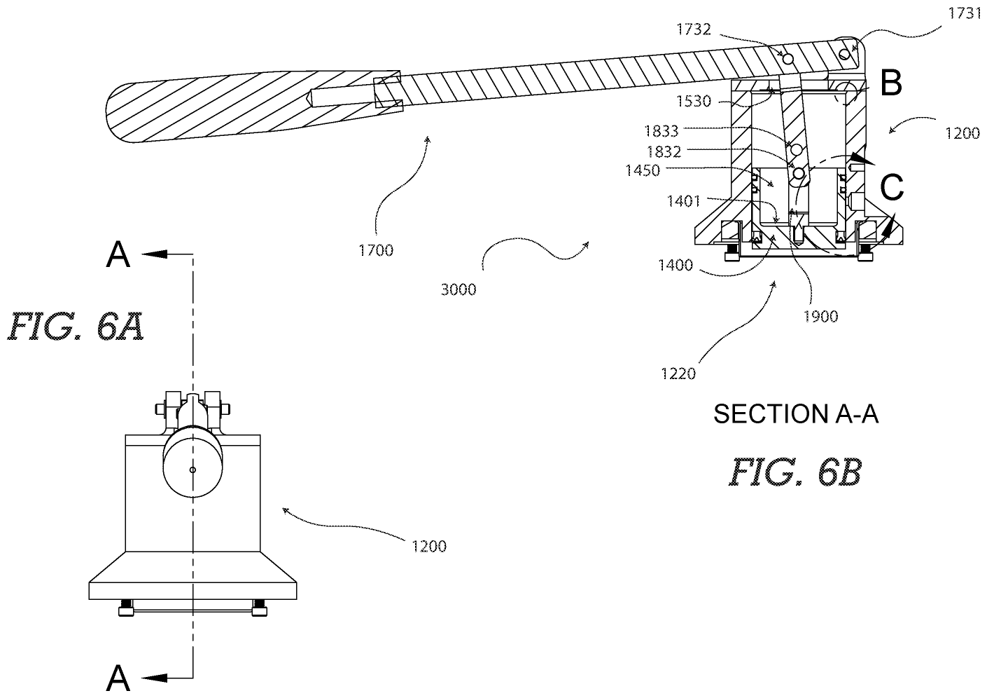

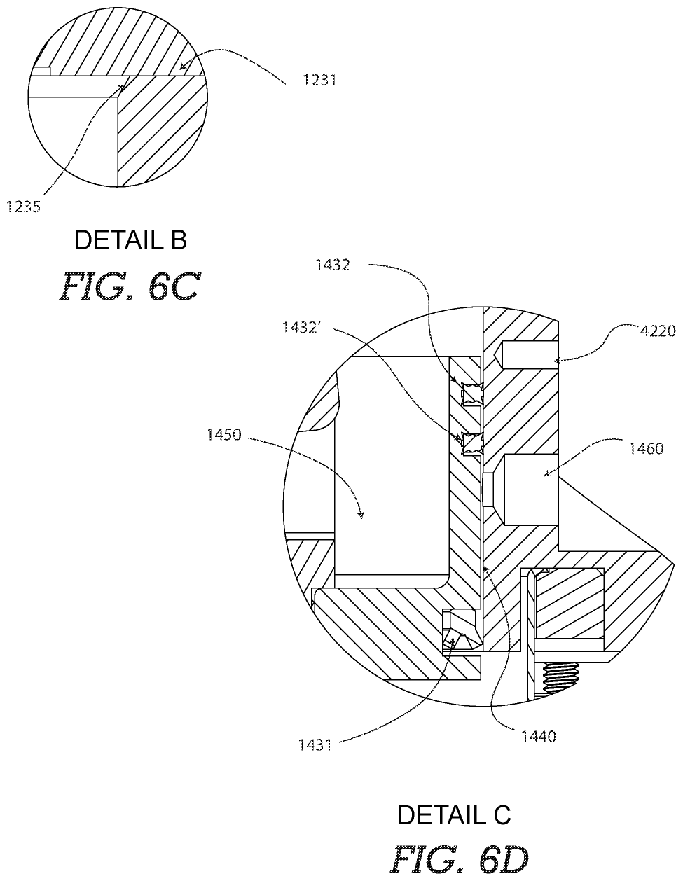

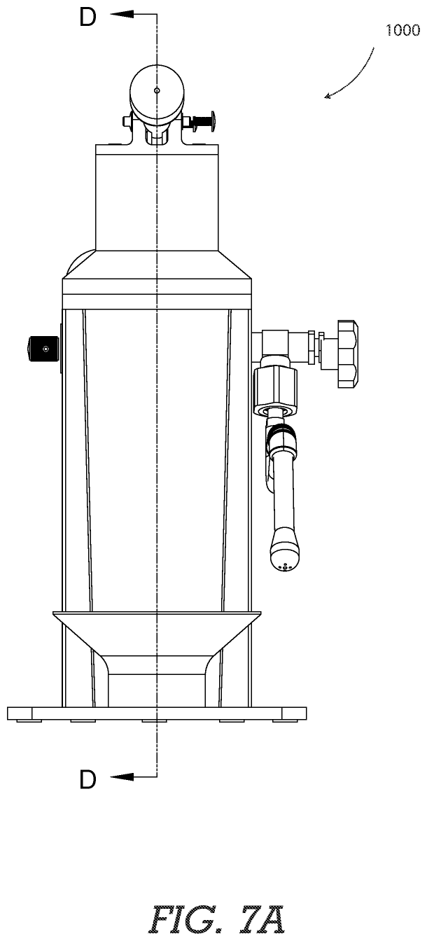

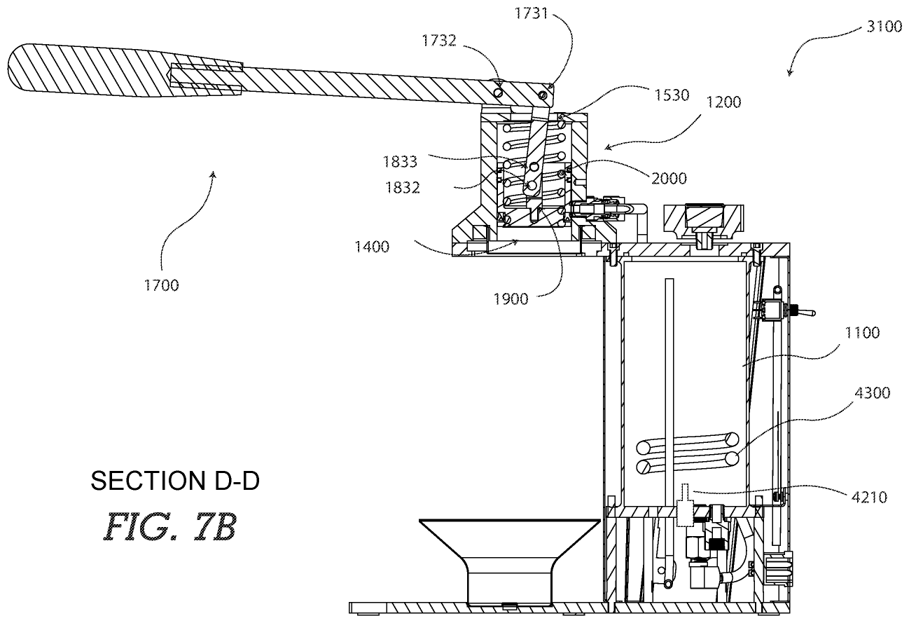

In certain embodiments, as shown in FIG. 6A-FIG. 6D for example, a piston 1400 comprises three sealing elements 1430: a first sealing ring 1431 adjacent to the bottom aspect of the piston, and two sealing rings 1432, 1432′ adjacent the top aspect of the piston. Embodiments comprising alternate configurations and alternate numbers of sealing elements 1430 are within the spirit and scope of the present invention. Furthermore, sealing rings as referred to herein include sealing rings comprising profiles including, but not limited to: O-rings, X-rings, Double X-rings, U-cup seals, and resealing rings comprising a square or rectangular profile. In certain embodiments, the piston 1400 comprises a recess 1450 extending from the top aspect 1410 of the piston toward the bottom aspect 1420 of the piston. In certain embodiments, the recess 1450 is configured to receive a spring 2000 (FIG. 7B).

In certain embodiments, as shown in FIG. 6A-FIG. 7B for example, a flange 1500 acts as a mechanical stop which prevents the piston from over-travel wherein the top of the piston 1410 traverses past the top aspect 1210 of the brewing chamber, and thus maintaining sealing engagement between the bore 1230 of the brewing chamber and the sealing elements 1430 of the piston. During the upstroke, the brewing chamber 1200 receives hot water from the boiler 1100 though the tube 1300 wherein the hot water is received between the bottom aspect 1420 of the piston through a water inlet 1460 and into the bottom aspect 1220 of the brewing chamber. During a downstroke, the piston 1400 travels downward through the bore 1230 of the brewing chamber. The downward travel of the piston 1400 generates pressure to force the hot water received within the brewing chamber 1200 downward through the ground coffee and through the filter 1600, thereby dispensing the coffee into a container placed below the filter.

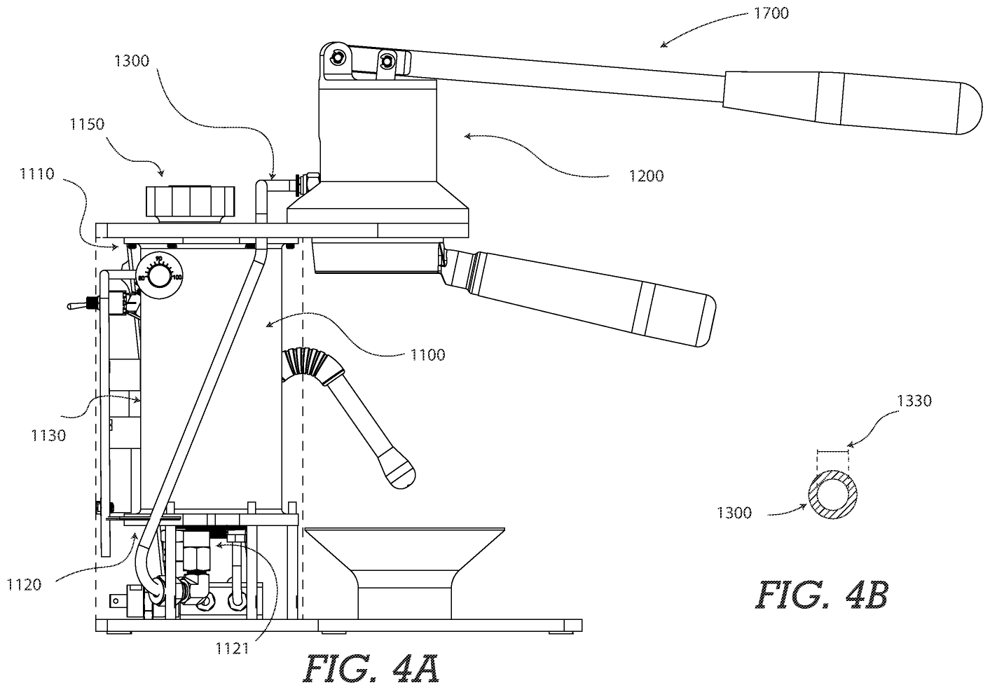

In certain embodiments, as shown in FIG. 6A-FIG. 6B for example, water is communicated from the boiler 1100 to the brewing chamber 1200 through a tube 1300 which takes an extended or tortuous path between the boiler 1100 and the brewing chamber 1200. In certain embodiments the tube 1300 exits the bottom aspect of the boiler 1120 through a one-way check-valve 1121 (FIG. 4A), and extends upward toward the brewing chamber 1200, and into the bore 1230 of the brewing chamber. Although embodiments described and shown herein comprise the tube 1300 exiting the bottom aspect 1120 of the boiler and traversing upward toward a brewing chamber 1200 located vertically above the boiler 1100, embodiments wherein the tube 1300 exits a side aspect 1130 or top aspect 1110 of the boiler prior to taking an extended or tortuous path between the boiler 1100 and the brewing chamber 1200 are within the spirit and scope of the present invention. A tortuous path as referred to herein surrounds the routing of the tube in a manner which is generally seen as inefficient for the conservation of thermal energy, wherein the length of travel between a first end 1310 and a second end 1320 of a tube taking a tortuous path is equal to or greater than 20 times the inner diameter 1330 of the tube. In certain embodiments a tortuous path of the tube 1300 comprises a length of travel of greater than 40 times the inner diameter 1330 of the tube 1300. In alternate embodiments, a tortuous path comprises a length of travel of greater than 60 times the inner diameter 1330 of the tube.

In certain embodiments, as shown in FIG. 6B-FIG. 6C for example, the top aspect 1231 of the bore of the brewing chamber comprises a chamfer 1235 wherein the chamfer 1235 assists in the reassembly of the piston 1400 within the bore 1230 of the brewing chamber, in the event the piston 1400 is removed from the bore 1230 of the brewing chamber. The chamfer 1235 allows the installation of the piston 1400 wherein the chamfer 1235 acts as a ramped surface to compress the sealing elements 1430 inward toward the piston 1400 as the piston is reinstalled within the bore 1230 of the brewing chamber by pushing the piston 1400 downward into the bore 1230 of the brewing chamber.

In certain embodiments, as shown in FIG. 5A-FIG. 5B for example, a brewing chamber 1200 comprises a mechanical stop comprising a flange 1500, wherein the flange 1500 comprises an aperture 1510 which is colinear with the bore 1230 of the brewing chamber. The aperture 1510 of certain embodiments intersects the central axis 1237 of the bore of the brewing chamber. The brewing chamber 1500 further comprises an interconnection point 1530 for the interconnection of a lever 1700 thereto, wherein the interconnection point 1530 is interconnected to top aspect 1210 of the brewing chamber. In certain embodiments the interconnection point 1530 is interconnected to a flange 1500 which is removably interconnected to the top aspect 1210 of the brewing chamber. The flange 1500 further comprises an interconnection point 1530 for the interconnection of a lever 1700 thereto. The interconnection point 1530 of certain embodiments comprises a first tab 1531 extending upwards from a top surface 1510 of the flange. The tab is configured 1531 is configured to interconnect with the lever 1700 in a pivoting connection. In certain embodiments, the first tab comprises 1531 comprises an aperture 1533 therethrough for the interconnection of the lever 1700 thereto with a pivoting connection. In certain embodiments, the interconnection point of the flange comprises a clevis. Alternate embodiments which comprise an interconnection point 1530 of the flange allowing the pivoting interconnection of the lever 1700 thereto are within the spirit and scope of the present invention.

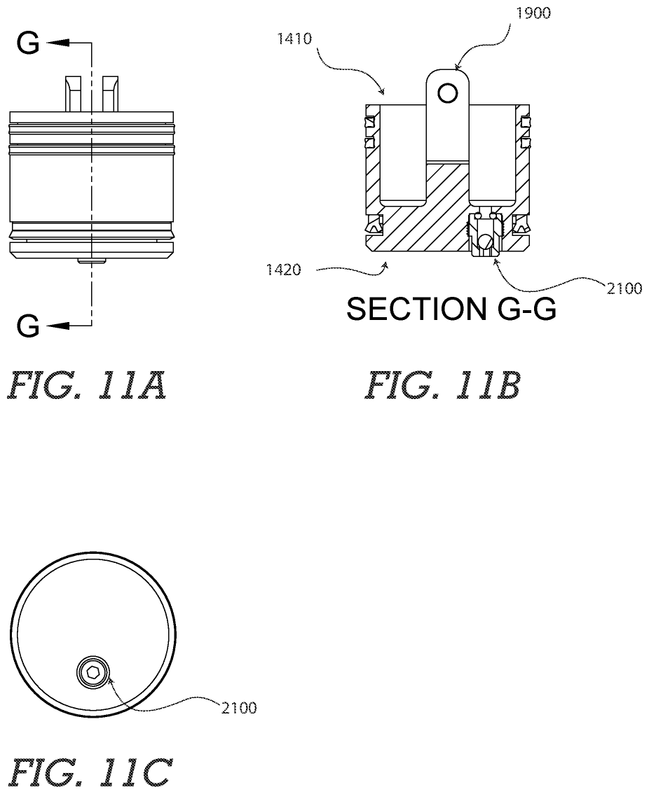

In certain embodiments, as shown in FIG. 5A-FIG. 5B for example, the lever 1700 comprises a first end 1710 having a distally located first aperture 1731 therethrough, and a second aperture 1732 offset proximally from the first hole 1731. A linkage 1800 extends between, and interconnects the lever 1700 to the piston 1400. The linkage comprises a first end 1810 having a distally located first aperture 1831. The second end of linkage 1820 further comprises a first aperture 1832, and a second aperture 1833 through the second end 1820 of the linkage wherein the first aperture 1832 is distally located, and the second aperture 1833 is proximally offset from the second aperture 1832. The first end 1810 of the linkage is configured to interconnect with the first end 1710 of the lever, and the second end 1820 of the linkage is configured to interconnect with the piston 1400. In certain embodiments the piston 1400 comprises a post 1900 having a first end configured to interconnect with the second end 1820 of the linkage resulting in a pivoting connection, and a second end 1920 configured to interconnect with the piston. In certain embodiments, first end 1910 of the post comprises an aperture 1930 therethrough. In certain embodiments as shown in FIG. 5B, the post is removably interconnectable to the piston 1400. Alternate embodiments, such as those shown in FIG. 11A—FIG. 11C comprise a post 1900 which is integrally interconnected with the piston 1400. In certain embodiments, the post 1900 is interconnected to a top surface 1401 of the piston.

In certain embodiments, as shown in FIG. 5A-FIG. 7B for example, a coffee brewing apparatus 1000 is modularly reconfigurable wherein the apparatus can be configured in a direct lever 3000, or a spring lever 3100 configuration. In order to reconfigure the apparatus 1000 between the direct lever 3000 and spring lever 3100 configurations, a user reconfigures the interconnection of the lever 1700 to the piston 1400 and the flange 1500.

In a direct lever configuration 3000, as shown in FIG. 6A-FIG. 6B for example, the first aperture 1731 of the lever is interconnected with the interconnection point 1530 of the flange, and the second aperture 1732 of the lever is interconnected with the first aperture 1831 of the linkage. Alternate embodiments wherein the interconnection point 1530 is interconnected to an alternate portions of the brewing apparatus, such as the brewing chamber, the boiler top-plate, or otherwise, are within the spirit and scope of the present invention.

In a spring configuration 3100, as shown in FIG. 7A-FIG. 7B for example, a compressive spring 2000 is disposed between the top aspect 1410 of the piston and the flange 1500, the first aperture 1710 of the lever is interconnected with the first aperture 1810 of the linkage, and the second aperture 1732 of the lever is interconnected with the interconnection point 1530 of the flange. In certain embodiments, the compressive spring 2000 is disposed within the recess 1450 of the piston.

In certain embodiments, in a direct lever 3000 configuration (FIG. 6B), the second aperture 1832 of the linkage is interconnected with the aperture 1930 of the post. Alternatively, in a spring lever configuration 3100 (FIG. 7B), the third aperture 1833 of the linkage is interconnected with the aperture 1930 of the post.

In certain embodiments the post 1900 comprises a clevis 1940. However, alternative embodiments where the second end 1820 of the linkage comprises a clevis are within the spirit and scope of the present invention.

In certain embodiments, the first end 1810 of the linkage comprises a clevis 1840. However, alternative embodiments wherein the first end 1710 of the lever comprises a clevis are within the spirit and scope of the present invention.

In certain embodiments, as shown in FIG. 5A-FIG. 7B for example, the flange 1500 is configured to be alternatively mounted 180-degrees offset between the direct lever 3000 and the spring lever configurations 3100, thereby maintaining the second end 1720 of the lever in a position wherein it extends away from the apparatus. In certain embodiments the flange 1500 is interconnected with the top aspect 1210 of the brewing chamber using threaded fasteners, wherein the fastener pattern is mirrored, thereby allowing for 180-degree offset mounting. Alternate embodiments wherein the interconnection of the flange to the top aspect of the brewing chamber use fastening strategies such as a bayonet mount, cam-lock mount, tab-and-slot, or cam-and-groove mechanisms are within the spirit and scope of the present invention.

Alternate embodiments wherein the flange 1500 is configured to be rotated 180-degrees without disconnection of the flange 1500 from the top aspect 1210 of the brewing chamber, are within the spirit and scope of the present invention.

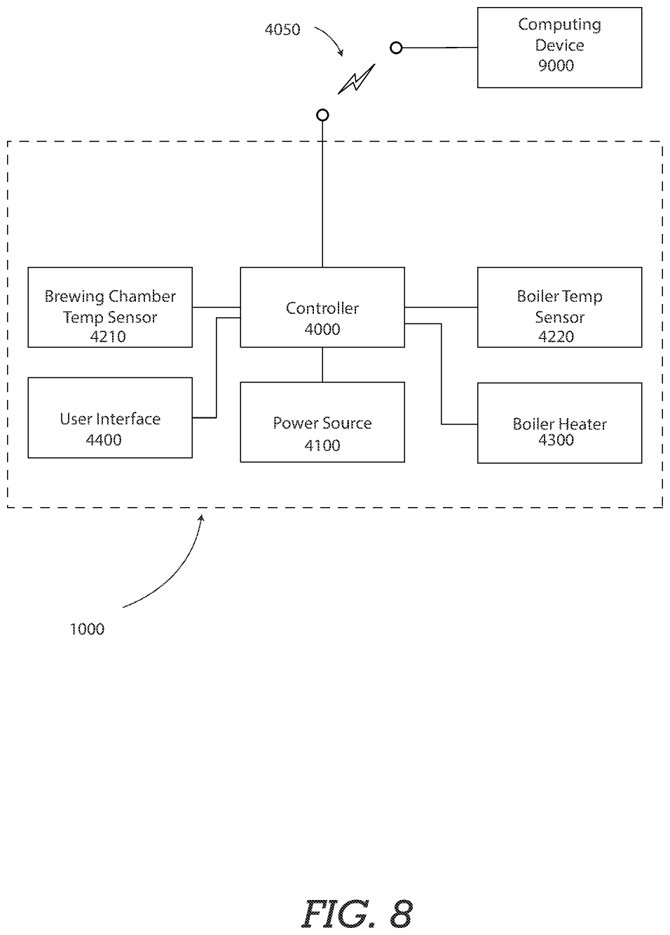

Certain embodiments of an apparatus for brewing coffee, as shown in FIG. 8 for example, comprise a controller 4000 having a power source 4100, wherein the processor 4000 comprises interconnection to at least one data gathering device 4200. A data gathering device 4200 as referred to herein includes pressure sensors, temperature sensor, and/or flow sensors. In certain embodiments the controller 4000, having a power source 4100, is interconnected with at least one data gathering device 4200 for detecting data, recording data, and communicating said data to the user wirelessly 4050 over wireless communication protocols. The controller 4000 communicates the data to the user through a wirelessly connected computing device 9000 such as a smart phone, smart watch, or other wirelessly connected computing device.

In certain embodiments the controller 4000 has communication with a first temperature sensor 4210 configured to measure the temperature of water held within the boiler 1100, and a second temperature sensor 4220 configured to measure the temperature of the brewing chamber 1200. The controller has further communication with the heating element 4300 configured to heat the temperature of the water within the boiler 1200. Thus, the controller can be configured to heat the water within the boiler 1200 to a setpoint in view of the temperature of the brewing chamber 1200 and a user desired beverage temperature, wherein the temperature of a dispensed beverage is at the user desired beverage temperature.

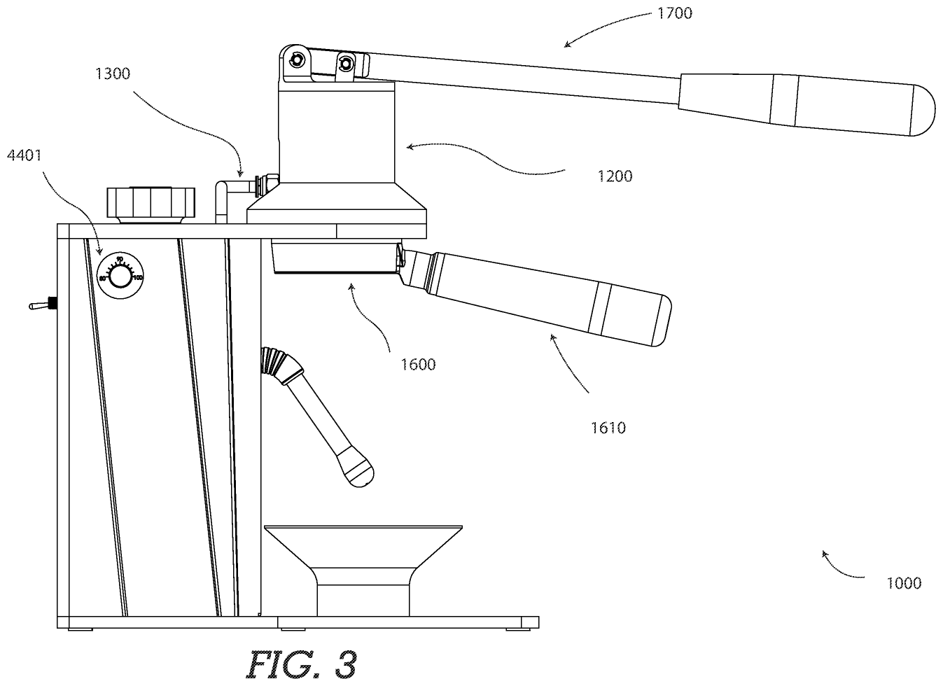

In certain embodiments, as shown in FIG. 3 and FIG. 8 for example, the apparatus comprises a user interface 4400 wherein a user can provide a desired temperature for a dispensed beverage wherein the user interface has interconnection with the processor. In certain embodiments the user interface having electrical connection with the controller 4000, while alternate embodiments comprise a user interface 4400 which is wirelessly connected with the processor. Further embodiments comprise a user interface 4400 comprising a dial 4441 which a user manually selects their desired beverage temperature.

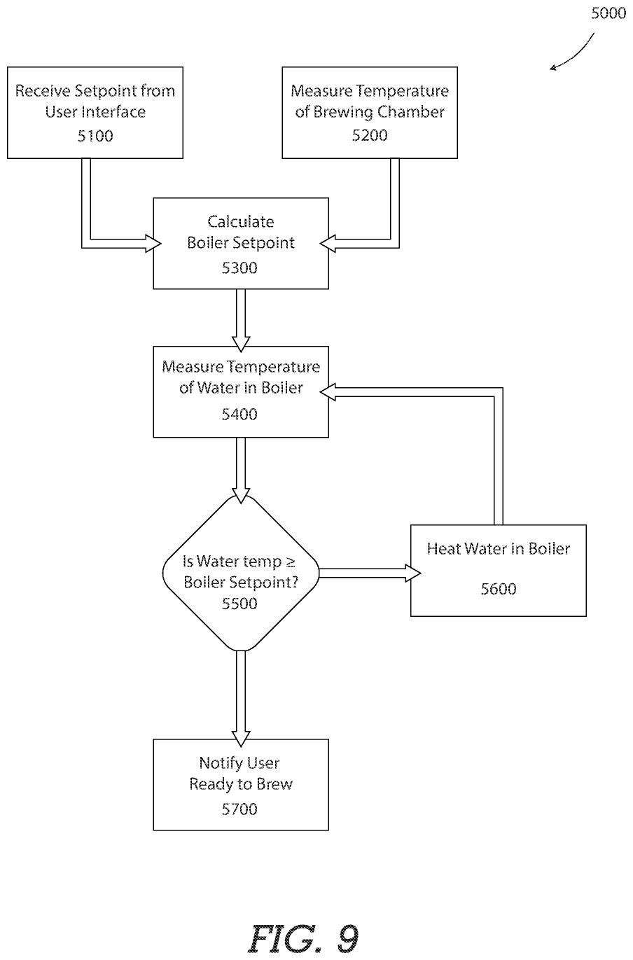

In certain embodiments, as shown in FIG. 9 for example, a process 5000 for brewing coffee comprises receiving a setpoint 5100 from the user indicating a desired beverage temperature, and measuring 5200 the temperature of a brewing chamber. The desired beverage temperature and the current temperature of the brewing chamber are used to calculate 5300 a boiler setpoint temperature at which to prepare water within the boiler. Following the calculation step 5300, a step of measuring the temperature of the water in the boiler 5400, after which the temperature of the water in the boiler is compared 5500 to the boiler setpoint. If the water temperature is below the boiler setpoint, the heating of the water in the boiler 5600 occurs. Once the temperature of the water in the boiler is equal to or greater than the setpoint, the user is notified 5700 of a ready to brew status. Alternate embodiments comprising a comparison step 5500 wherein it is desired for the temperature of the water within the boiler is equal to, equal to or less than, or within a predetermined range of the calculated setpoint are within the spirit and scope of the present invention. In certain embodiments, the rate of heat loss between the boiler and the brewing chamber is known wherein the heat loss between the boiler and group head can be accounted for in calculating 5300 the setpoint temperature. Furthermore, in certain embodiments the thermal mass of the brewing chamber is known, wherein the thermal mass of the brewing chamber can be accounted for in the calculation of the setpoint temperature, resulting in a beverage being brewed at the desired temperature. In certain embodiments, the heat loss between the boiler and the brewing chamber and the thermal mass of the brewing chamber are accounted using a constant which estimates heat lost to the environment between the boiler and the brewing chamber, and the heat lost to heating the brewing chamber.

In certain embodiments, the setpoint temperature of the boiler is calculated 5300 by the following:

Tₛₑₜₚₒᵢₙₜ=Tᵤₛₑᵣ+((Tᵤₛₑᵣ−T_{Chamber}*C)

Wherein Tₛₑₜₚₒᵢₙₜ temperature at which the water in the boiler is prepared to, Tᵤₛₑᵣ is the desired beverage temperature received by the user, T_{Chamber} is the temperature of the brewing chamber as detected by the thermocouple, and C is a thermal gain value coefficient, wherein C is less than 1. In certain embodiments, C is a coefficient of value between 0.45 and 0.65 of the water in the boiler to result in a beverage dispensed at the desired beverage temperature.

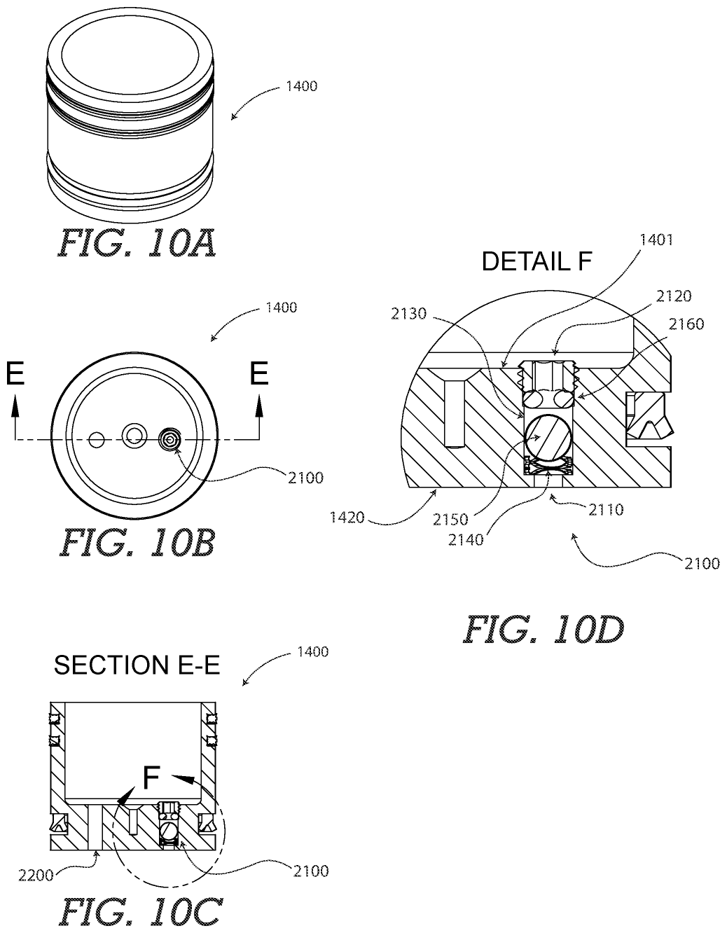

In certain embodiments, as shown in FIG. 10A-FIG. 10D for instance, a coffee brewing apparatus comprises a device configured to purge air entrapped between the ground coffee and the piston 1400 through a one-way valve or purge valve 2100 extending from a bottom aspect 1420 of the piston and through the top surface 1401 of the piston, to allow venting of air from the brewing chamber 1200 to the ambient. In certain embodiments the purge valve comprises pathway 2130 therethrough, a spring 2140, and a poppet 2150. The poppet 2150, an element configured to move along the pathway 2130, is configured to allow gas to escape through the pathway 2130, but not liquid. In certain embodiments as shown in FIG. 10D, the poppet 2150 is comprises a spherical element, however alternate geometric shapes of the poppet 2150 are within the spirit and scope of the present invention. The spring 2140 is configured to prevent the poppet 2150 from blocking first end 2110 of the pathway and thus allowing air to pass freely around the poppet 2150, and through the second end 2120 of the pathway. In the event water or other liquid enters the first end 2110 of the pathway, the poppet 2150 is configured to be forced toward the second end 2120 of the pathway and thus blocking the second end 2120 of the pathway and preventing water from passing through the pathway 2130 of the purge valve. Therefore, when hot water is delivered to the brewing chamber 1200 from the boiler 1100, the water is permitted to displace the air contained therein as the air is vented through the valve 2100. In certain embodiments, a sealing element 2160 disposed between the poppet 2150 and the second end 2120 of the pathway creates a seal between the poppet 2150 and the sealing element 2160. Furthermore, when the piston 1400 is pressed downward through the bore 1230 of the brewing chamber (FIG. 5A-FIG. 5B), any air entrapped between the piston 1400 and the ground coffee can be purged without loss of water from the brewing chamber 1200, through the purge valve. In certain embodiments, wherein a pump or positive pressure is used to deliver water from the boiler 1100 (FIG. 7B) to the brewing chamber, the water is able to fill the brewing chamber 1200 completely as the air is purged out from the brewing chamber 1200 through the purge valve 2100 interconnected with the piston 1400. As shown in FIG. 10B, the purge valve assembly 2100 is configured to be removed through the use of a tool, such as a hex tool or allen wrench for maintenance and replacement purposes, wherein the purge valve 2100 is removed from the direction of the first end 1410 of the piston.

In certain embodiments, as shown in FIG. 10C for instance, an aperture 2200 through the bottom surface of the piston 1400 allows for the interconnection of ancillary elements such as a pressure gauge to allow a user to monitor the pressures within the brewing chamber.

In certain embodiments, as shown in FIG. 11A-FIG. 11C for instance, the purge valve 2100 is configured to be interconnected to the piston 1400 wherein the purge valve 2100 is configured to be interconnected and removeable from the piston 1400 from the second end 1420 of the piston.

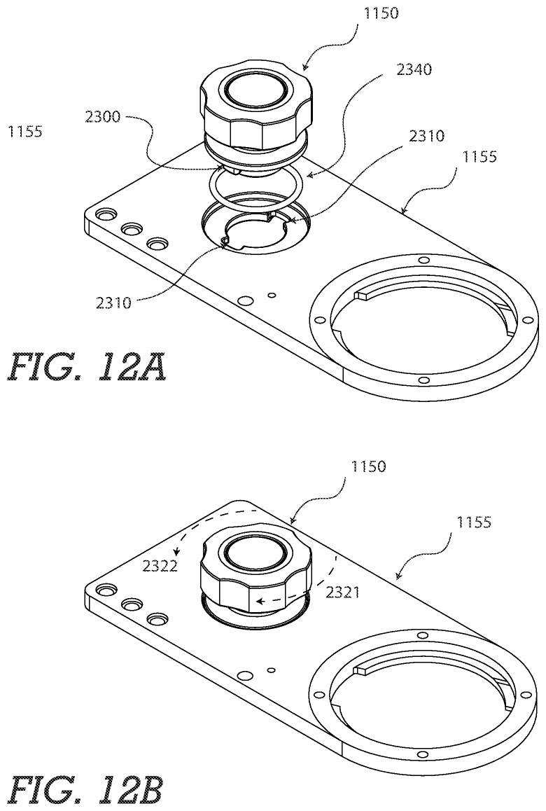

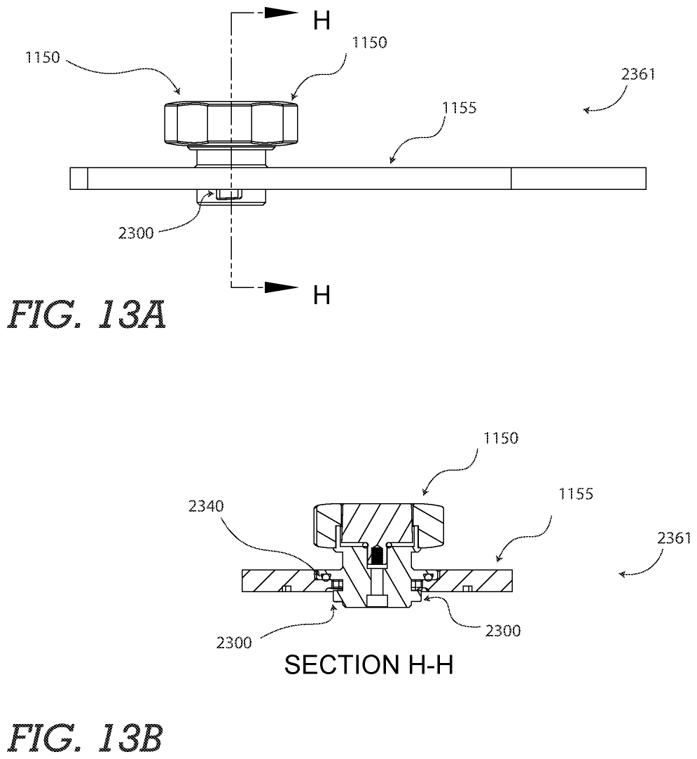

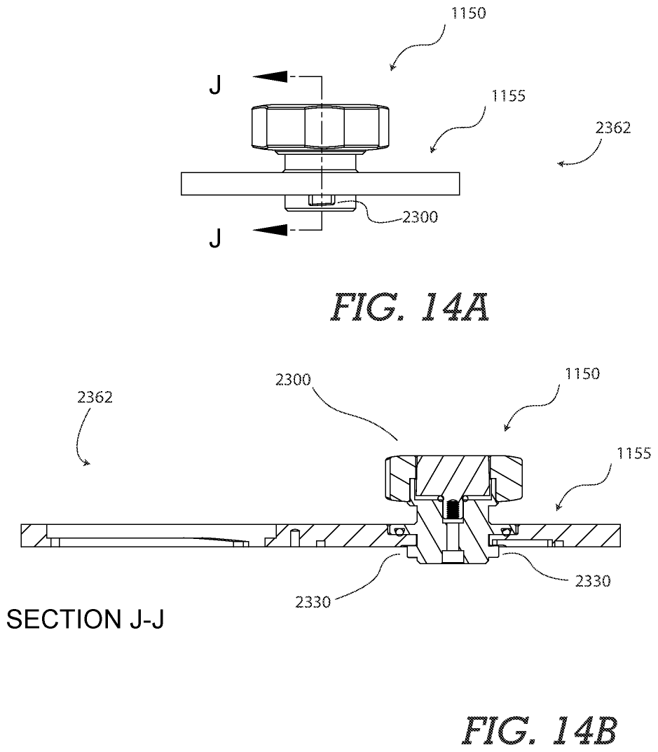

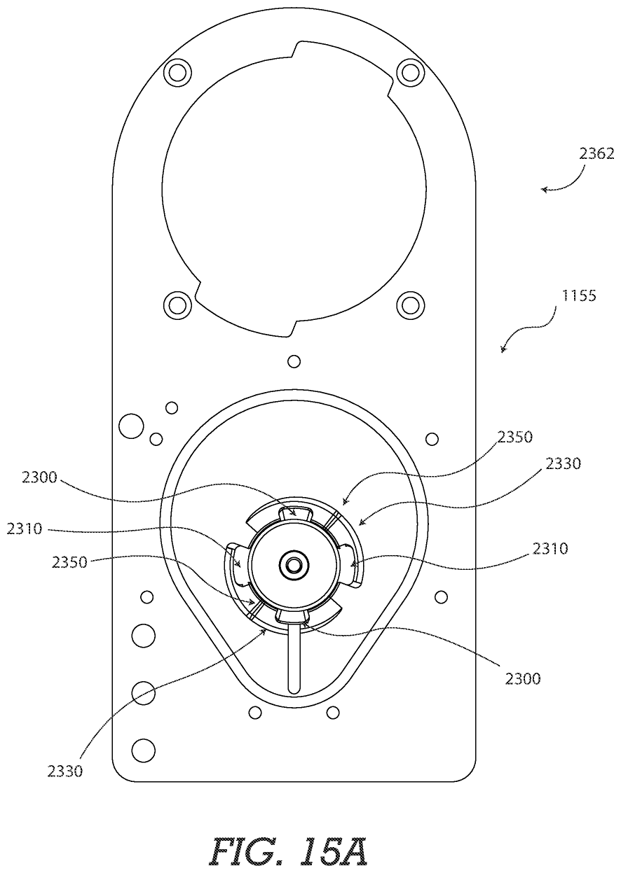

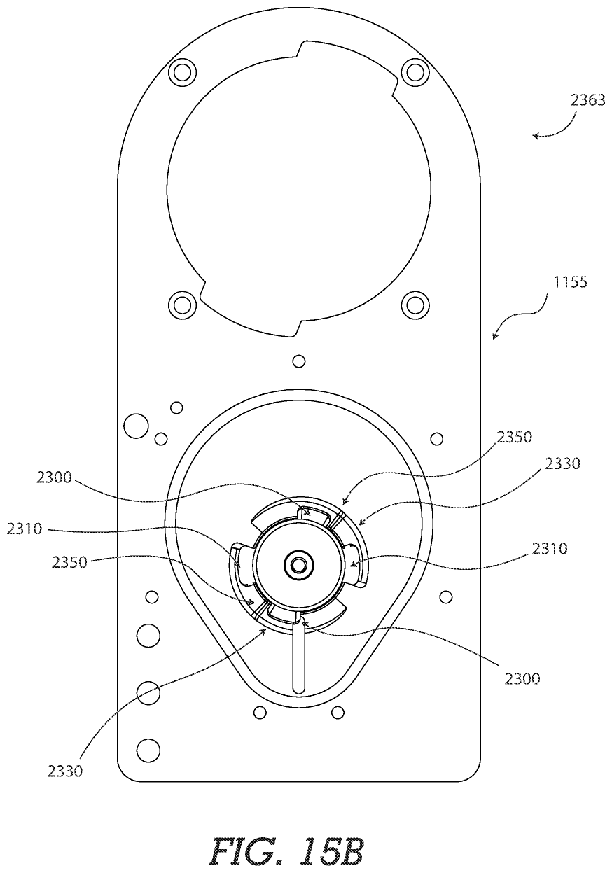

In certain embodiments, as shown in FIG. 12A-FIG. 15B for instance, the boiler cap 1150 comprises a partial turn, such as a quarter turn operation to remove it from the top-plate 1155 of the boiler 1100 for filling. The boiler cap 1150 comprises cams 2300 which are configured to be received through a keyway 2310 in the top-plate 1155 of the boiler. When the cams 2300 are inserted through the keyways 2310 and the boiler cap 1150 is rotated in a first direction 2321, the cams 2300 engage ramped features 2330 which serve to lock the boiler cap 1150 in place. Locking the boiler cap 1150 in place compresses a seal 2340 between the boiler cap 1150 and the top-plate 1155 for providing an air-tight seal through which building pressure of steam generated by the boiler cannot escape in a sealed configuration as seen in FIG. 14A—FIG. 15A. The ramped features 2330 extend in an arced fashion wherein the cams 2300 are configured to interface with the ramped features 2330 as the boiler cap 1150 and thus the cams 2300 are rotated in a first direction 2321 or a second direction 2322. As the cams 2300 ride along the ramped features 2330 as the boiler cap 1150 is rotated, the ramped features 2330 direct the cams 2300 away from the top surface 1156 of the top-plate and further compress the seal 2340. The ramped features 2330 effectively increase the local thickness of the top plate the top plate wherein the compression of the seal increases as the boiler cap 1150 is rotated in a first direction 2321. The embodiments shown in FIG. 13A-FIG. 13B show a boiler-cap 1150 in an unlocked configuration 2361. The embodiments shown in FIG. 14A-FIG. 15A show a boiler cap 1150 in a locked configuration 2362. The embodiment shows in FIG. 15B for instance, show a boiler cap 1150 in a vented configuration 2363.

In certain embodiments the ramped features further comprise a safety feature 2350 proximal to the keyways 2310 wherein the safety feature 2350 comprises a bump, nodule, depression, or protrusion. The safety feature as shown in FIG. 15A-FIG. 15B comprises a bump. The safety feature 2350 is configured to prevent the inadvertent opening of the boiler cap 1150 when the boiler is pressurized, thereby preventing injury. If the boiler cap 1150 is rotated in a second direction 2322 in efforts to remove the boiler cap 1150 when the boiler is under pressure, the pressure within the boiler forces the boiler cap 1150 and thereby the cams 2300 upward to engage with the safety features 2350 and prevent the removal of the boiler cap 1150 until the pressure reaches a safe state. In certain embodiments, the safety features 2350 are located along the ramped features 2330 so as to constrain the boiler cap 1150 in a venting configuration 2363, such as shown in FIG. 15B, wherein the seal 2340 is not fully compressed and allows pressure to vent past the seal 2340. Once the pressure has subsided within the boiler, a user is then able to complete the rotation of the boiler cap in the second direction 2322 to allow the removal of the boiler cap 1150.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. An apparatus for brewing coffee, comprising:
a brewing chamber having a hollow cylindrical bore having a diameter, the brewing chamber configured to receive water therein for brewing coffee;
a filter configured to receive ground coffee, and wherein the filter is configured to interconnect with a bottom aspect of the brewing chamber;
a piston configured to slidably interconnect with the brewing chamber, wherein the piston is configured to induce pressure to drive water through the filter when the piston travels downward through the hollow bore of the brewing chamber;
the piston comprising an interconnection point interconnected to the top surface of the piston;
a lever having a first end and a second end, the lever further comprises a first interconnection point through the first end of the lever, and a second interconnection point through the lever is offset proximally from the first interconnection point of the lever by a distance less than the diameter of the cylindrical bore;
a linkage comprising a first end configured to pivotally interconnect with the interconnection points of the lever, and the linkage comprising a second end configured to pivotally interconnect with the interconnection point of the piston;
the brewing chamber further comprising an interconnection point proximal to top aspect of the brewing chamber;
wherein in a direct lever configuration: the first interconnection point of the lever is pivotally interconnected with the interconnection point of the brewing chamber, the second interconnection point of the lever is pivotally interconnected with the first end of the linkage, and the interconnection point of the piston is pivotally interconnected with the second end of the linkage, and
wherein in a spring lever configuration: the first interconnection point of the lever is pivotally interconnected with the first end of the linkage, the second interconnection point of the lever is pivotally interconnected with the interconnection point of the brewing chamber, and the interconnection point of the piston is pivotally interconnected with the second end of the linkage.

2. The apparatus of claim 1, wherein the interconnection point of the brewing chamber is interconnected with a flange, wherein the flange is removably interconnected with the top aspect of the brewing chamber.

3. The apparatus of claim 2, wherein the flange is interconnected with the top aspect of the brewing chamber in a first orientation in relation to the brewing chamber in a direct lever configuration, and
wherein in a spring lever configuration the flange is interconnected with the top aspect of the brewing chamber in a second orientation, 180-degrees opposed to the first orientation.

4. The apparatus of claim 2, wherein the interconnection point of the flange comprises a clevis;
and the interconnection points of the lever each comprise an aperture,
wherein the clevis of the flange is configured to interconnect to each of the interconnection points of the lever.

5. The apparatus of claim 4, wherein the first end of the linkage comprises a clevis configured to interconnect with each of the interconnection points of the lever.

6. The apparatus of claim 5, wherein the second end of the linkage comprises a first interconnection point and a second interconnection point,
wherein first interconnection point of the second end of the linkage is distally located, and the second interconnection point of the second end of the linkage is proximally offset therefrom.

7. The apparatus of claim 6, wherein the first interconnection point of the second end of the linkage comprises an aperture, and
wherein the second interconnection point of the second end of the linkage comprises an aperture.

8. The apparatus of claim 7, wherein the interconnection point of the piston comprises a clevis configured to interconnect with the apertures of the second end of the linkage.

9. The apparatus of claim 7, wherein in a direct lever configuration, the first aperture of the second end of the linkage is interconnected with the clevis of the piston, and
wherein in a spring lever configuration, the second aperture of the second end of the linkage is interconnected with the clevis of the piston.

10. The apparatus of claim 9, wherein the clevis of the piston is interconnected to a first end of a post, wherein the second end of the post is interconnected to the top surface of the piston,
wherein the clevis of the piston is offset upward from the top surface of the piston.

11. The apparatus of claim 1, wherein the piston comprises a first aperture extending from a bottom aspect of the piston through the top surface of the piston.

12. The apparatus of claim 11 further comprising a purge valve interconnected with the first aperture of the piston, wherein the purge valve is adapted for allowing the passage of air from the brewing chamber and through the purge valve, and
wherein the purge valve is configured to prevent the passage of water from the brewing chamber through the purge valve.

13. The apparatus of claim 12, wherein the purge valve is configured to vent air from the brewing chamber to ambient.

14. The apparatus of claim 13, wherein the purge valve is removably interconnected with the piston.

15. The apparatus of claim 14, is removable from the piston from the bottom aspect of the piston.

16. The apparatus of claim 13, wherein the piston further comprises a second aperture extending from the bottom aspect through the top surface of the piston.

17. The apparatus of claim 16, wherein the second aperture is configured to have ancillary components interconnected thereto.

18. The apparatus of claim 17, wherein an ancillary component comprises a pressure gauge.

19. The apparatus of claim 1, further comprising a boiler; and
a boiler cap adapted for sealing the aperture of the boiler,
wherein the boiler cap comprises an unlocked configuration permitting the removal of the boiler cap from the boiler to allow filling the boiler with water,
wherein the boiler cap further comprises a locked configuration, thereby sealing the boiler and preventing venting past the boiler cap, and
wherein the boiler cap further comprises a venting configuration, wherein pressure venting is permitted past the boiler cap.

20. The apparatus of claim 19, wherein a safety feature prevents the rotation of the boiler cap from a vented configuration to an unlocked configuration when there is a pressure differential between the boiler and ambient.
